(19) United States
(12) Patent Application Publication
(10) Pub. No.: US 2013/0322261 A1
(43) Pub. Date: Dec. 5, 2013

(54) Cell Association in Multi-Radio Access Technology Networks

(71) Applicants: Shu-Ping Yeh, Mountain View, CA (US); Nageen Himayat, Fremont, CA (US); Shilpa Talwar, Los Altos, CA (US); Kerstin Johnsson, Palo Alto, CA (US)

(72) Inventors: Shu-Ping Yeh, Mountain View, CA (US); Nageen Himayat, Fremont, CA (US); Shilpa Talwar, Los Altos, CA (US); Kerstin Johnsson, Palo Alto, CA (US)

(21) Appl. No.: 13/994,385

(22) PCT Filed: Dec. 29, 2011
(86) PCT No.: PCT/US11/67999

§ 371 Date: Jun. 14, 2013

(51) Int. Cl. H04W 48/18

(52) U.S. Cl. CPC H04W 48/18
USPC 370/241

(57) ABSTRACT

One of at least two available radio access technologies may be selected for a given radio communication. For example, quality of service or network loading may be used to make the selection.

### BACKGROUND

This relates generally to radio access technology networks in which a client device can connect to a base station or access point.

In multi-radio access technology networks, two different radio technologies may be available to clients in a given area. As an example, in a given area, a client radio device may have access to a WiFi network, as well as a long term evolution (LTE) network.

### BRIEF DESCRIPTION OF THE DRAWINGS

FIG. 1 is a depiction of a portion of a network in accordance with one embodiment of the present invention;

FIG. 2 is an example of two clients that can access two different radio access technology networks;

FIG. 3 is a flow chart for one embodiment of the present invention;

FIG. 4 is a flow chart for another embodiment of the present invention;

FIG. 5 is a flow chart for another embodiment of the present invention;

FIG. 6 is a flow chart for another embodiment of the present invention;

FIG. 7 is a flow chart for another embodiment of the present invention; and

FIG. 8 is a schematic depiction of a network control device and/or a client device within that network.

### DETAILED DESCRIPTION

In accordance with some embodiments, performance metrics may be evaluated and cell association and offloading rules may be adopted when two or more radio access technologies (RATs) are available. Thus, within a given area, client radio devices may select one or the other of the radio access technologies for instituting communications. The selection may be based on considerations of offloading and/or performance. In addition, in some cases, the same device can access different radio access technologies at the same time.

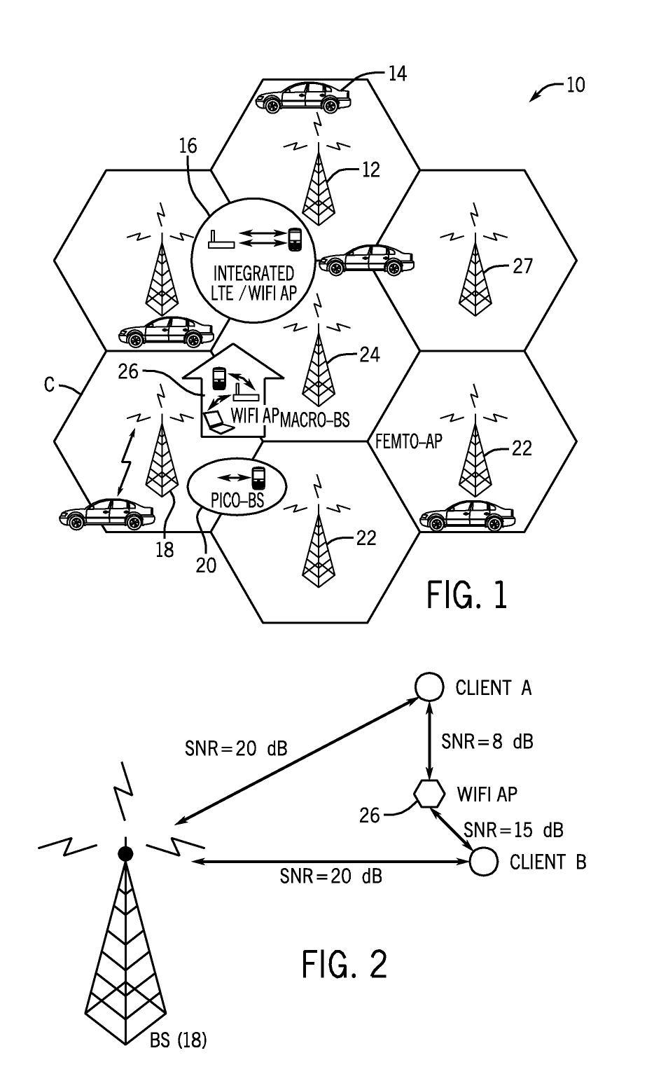

Referring to FIG. 1, a multi-tiered, multi-radio access network 10 example is given. In this example, client devices, such as the automobiles 14 have access to two different radio access technologies, including long term evolution (LTE) base stations (BSs) 12, 18, 22, 24, and 27 and WiFi access points (APs) 26. In addition, there are different tiers within the same network, including femto access points 22, pico base stations 20, and WiFi access points 26. In addition, there is a hybrid integrated LTE WiFi access point 16 in this example. Thus, in a given cell C, there may be different opportunities for selecting a particular radio access technology. This may be because there is a base station and an access point available within the same cell C.

A number of considerations may drive which radio access technology may be selected. Typical considerations may include improving load balancing between the different radio access technologies, improving reliability or reducing outages or improving quality of service metrics. Other quality of service metrics may include throughput, power efficiency, video quality, mobility, and expected duration of a connection, to mention a few examples. Thus, considerations of load balancing and quality of service metrics may be considered in selecting between the different available radio access technologies.

In some embodiments, the selection may be based at the client level and, in other embodiments, it may be based on the network level and, in still other embodiments, it may be based at the base station or access point level.

Thus, FIG. 2 provides an example where clients A and B have two different accessible radio access technologies. The base station 18 may be part of a long term evolution radio access technology and the access point 26 may be a WiFi access point. Thus, each of the clients A and B needs to select which access point or base station to use for radio communications. In one embodiment, a condition on each network (e.g. the WiFi and cellular networks) is determined and used to select the access point or base station that better meets the quality of service needs of the client or the networks as a whole. In this example, hypothetical signal-to-noise ratios are given to each client and each of the access point or base station.

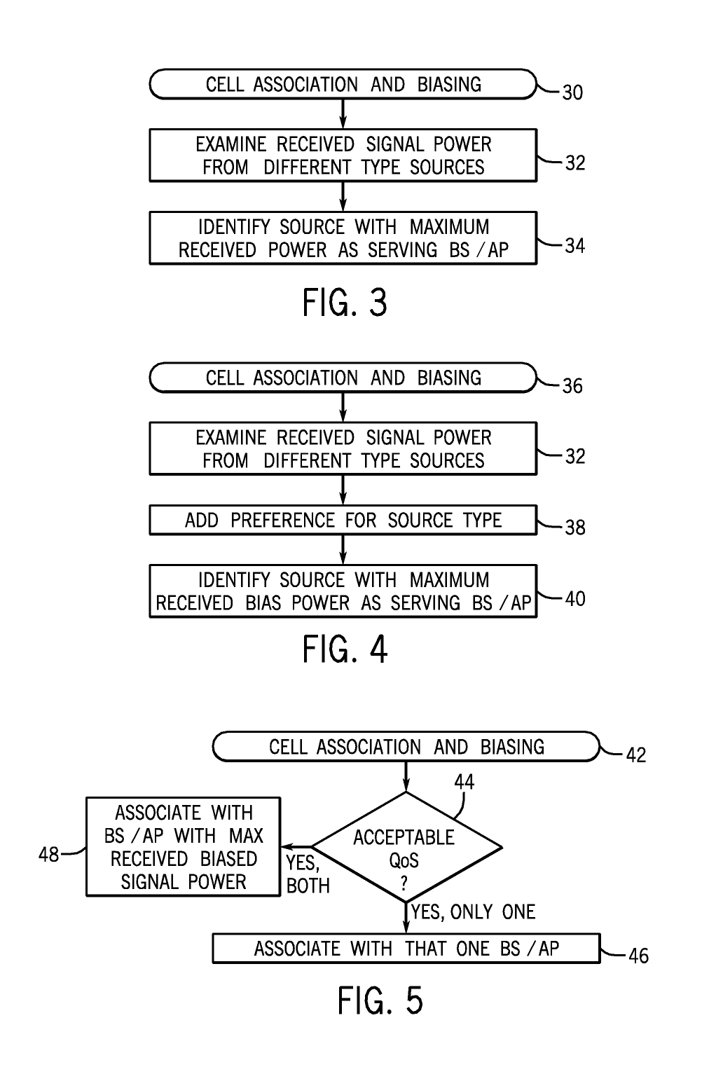

Thus, in accordance with one cell association and biasing rule sequence 30, shown in FIG. 3, a selection for cell association may be done without biasing based on a performance or quality of service metric, such as received signal power.

The sequence 30 may be implemented in a base station, access point, client, or on a network level (e.g. in a server). It may be implemented in hardware, software, and/or firmware. In firmware and software embodiments it may be implemented by computer executed instructions stored in a non-transitory computer readable medium, such as an optical, semiconductor, or magnetic storage device.

At block 32, the sequence determines how a condition, on each network such as received signal power from the different types of sources (in this example, LTE and WiFi), compares. Then, in block 34, the source is identified with the maximum received power and that source is selected as the radio access technology for the particular client.

In accordance with another embodiment, a bias for a particular radio access technology type may be used. This may be used for purposes of offloading. A bias may be added in order to encourage offloading from an overloaded network onto another network. Thus, as overloading increases, on one network, the bias for the other network may be increased on the fly.

A sequence 36, shown in FIG. 4, may be implemented in software, firmware, and/or hardware. In software and firmware embodiments, it may be implemented by computer executed instructions stored in a non-transitory computer readable medium, such as a semiconductor, optical, or magnetic memory.

The sequence 36 begins by examining (block 32) the received signal power or any other network condition from the different radio access technology type sources. Then a preference is added for a particular source type, such as WiFi, as indicated in block 38. The extent of the preference may be variable based on current conditions within the network. Finally, the source with the maximum received bias power or other metric is selected (block 40) as the serving base station or access point and, as a result, a radio access technology has been selected.

Thus, in the sequence 36, a bias or preference value is added to the received signal power to bias offloading from one overloaded radio access technology to another under loaded radio access technology. For example, a bias value may be set at any instance of time at ten decibels. If one network becomes more overloaded, the bias value could be increased. If the bias value is set for ten decibels, the client B (FIG. 2) will associate with the WiFi access point 26, while the client A (FIG. 2) will still associate with the base station 18.

The bias value can be determined globally, for example for all access points or base stations of a given technology or based on WiFi or alternative radio access point density and user distribution or locally by each access point or base station based on loading conditions. The bias value can even be made negative in the case where the alternative radio access technology actually needs to be offloaded for a period of time.

Moving to the next cell association and biasing rule illustrated in FIG. 5 by the sequence 42, cell association and biasing can be based on a quality of service enhanced biased metric, in some embodiments.

The sequence 42 may be implemented in software, firmware, and/or hardware. In software and firmware embodiments, it may be implemented by computer executed instructions stored on a non-transitory computer readable medium, such as an optical, semiconductor, or magnetic storage device.

The sequence 42 begins by determining whether there is an acceptable quality of service at diamond 44. There are many distinct types of quality of service metrics that may be considered including throughput, power efficiency, video quality, mobility and expected connection duration.

If there is only one acceptable quality of service radio access technology, then that base station or access point that implements that radio access technology is selected, as indicated in block 46. If both radio access technologies have an acceptable quality of service, then, in one embodiment, the client associates with that access point or base station with the maximum received biased signal power, as indicated in block 48.

As in the previous rule, the bias value can be global or local. However, this algorithm avoids the detrimental scenario possible with the previous rule where a strong bias results in clients associated with access points or base stations that cannot provide adequate quality of service.

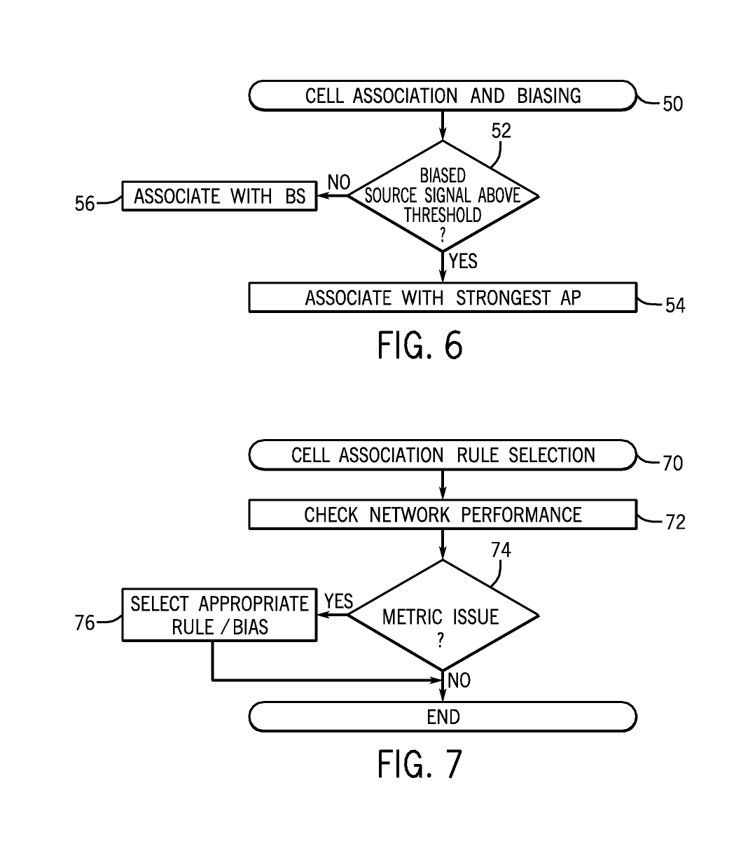

Moving to FIG. 6, the cell association and biasing rule associates with an alternative radio access technology, such as WiFi, if minimum quality of service requirements may be met and, otherwise, associates with the strongest macro base station.

The sequence 50 may be implemented in software, firmware, and/or hardware. In software and firmware embodiments, it may be implemented by computer executed instructions stored in a non-transitory computer readable medium, such as a magnetic, semiconductor, or optical storage.

As indicated in diamond 52, an initial check determines whether a bias source signal above a threshold can be detected. If so, the client associates with the strongest access point, as indicated in block 54. Otherwise, it associates with the primary radio access technology base station (block 56). Thus, in an example with WiFi, this rule always offloads the client to a WiFi radio access technology if the signal quality from the strongest WiFi access point is above the threshold required to successfully decode messages.

In the example of FIG. 2, both clients A and B would associate with the WiFi access point if the minimum required signal-to-noise ratio for successful decoding is seven decibels. This rule works better in sparse WiFi access point deployments where only a limited number of clients receive satisfactory signals strength from WiFi. Thus, this rule might maximize traffic offloading to WiFi to achieve better system performance.

In different scenarios different biases may be used and different rules may be selected. This may result in a different offloading rate to the alternative network, a different outage percentage, a different throughput in each network.

As shown in FIG. 7, a cell association rule selection sequence 70 may be used in some embodiments. The sequence 70 may be implemented in software, firmware, and/or hardware. In software and firmware embodiments, it may be implemented by computer executed instructions stored in a non-transitory computer readable medium, such as a semiconductor, optical, or magnetic storage. The sequence may be implemented at the client level, at the base station or access point level, or at a network level.

Initially, a check at block 72 determines whether any network performance metric needs to be improved. For example, the network performance metric may be a quality of service metric of the type already described. If so, as determined in diamond 74, an appropriate rule from the rules described above and an appropriate bias may be selected, as indicated in block 76.

Although examples are given in the context of multi-tier networks where a user may associate with only one access point at a time, the association rules are also applicable to other deployment scenarios including integrated multiple radio access technology access points, where a user can simultaneously connect using two radio access technologies.

As an example, a user with a multi-radio access technology device may simultaneously connect to a cellular base station and a WiFi access point. The user can select both the cellular base station and the WiFi access point based on existing cellular/WiFi association rules or a mix of the rules. In one scenario, a user may connect to the cellular base station for control signaling and may connect to the WiFi access point to offload data traffic. Here, a quality of service based offloading rule may be used where the association with the cellular base station may be based on reliability quality of service metrics and the WiFi association may be based on throughput quality of service metrics. Other disployment scenarios may include associating with an integrated WiFi and cellular base station, where only the cellular base station may be considered in the association decision based on a reliability quality of service criteria. The association with the WiFi access point then becomes automatic.

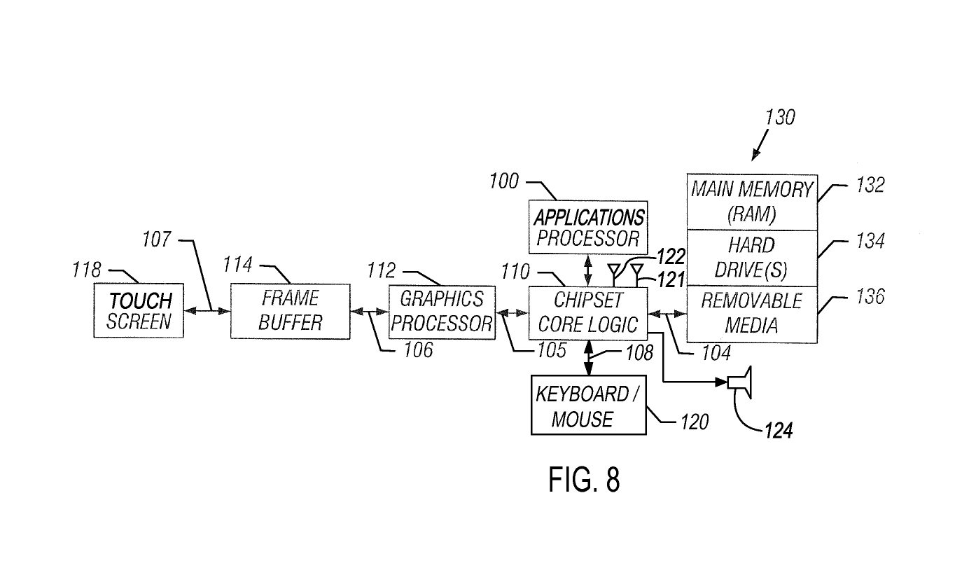

The computer system 130, shown in FIG. 8, may include a hard drive 134 and a removable medium 136, coupled by a bus 104 to a chipset core logic 110. The computer system may be any computer system that communicates wirelessly, including a smart mobile device, such as a smart phone, tablet, or a mobile Internet device, a base station, an access point or a network server. A keyboard and mouse 120, or other conventional components, may be coupled to the chipset core logic via bus 108. The core logic may couple to the graphics processor 112, via a bus 105, and the applications processor 100 in one embodiment. The graphics processor 112 may also be coupled by a bus 106 to a frame buffer 114. The frame buffer 114 may be coupled by a bus 107 to a display screen 118, such as a liquid crystal display (LCD) touch screen. In one embodiment, a graphics processor 112 may be a multi-threaded, multi-core parallel processor using single instruction multiple data (SIMD) architecture.

The chipset logic 110 may include a non-volatile memory port to couple the main memory 132. Also coupled to the logic 110 may be multiple antennas 121, 122 to implement multiple input multiple output (MIMO) in one embodiment. Speakers 124 may also be coupled through logic 110.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
evaluating conditions existing on two available radio access technologies, using a computer processor; and
selecting one of the two available radio access technologies for a wireless communication based on said existing conditions.

2. The method of claim 1 including selecting a radio access technology using an offloading rule.

3. The method of claim 1 including selecting between cellular and WiFi radio access technologies.

4. The method of claim 1 including selecting using a load balancing consideration.

5. The method of claim 1 including selecting to improve quality of service.

6. The method of claim 1 including selecting at a client level.

7. The method of claim 1 including selecting at a network level.

8. The method of claim 1 including selecting based on signal-to-noise ratio.

9. The method of claim 1 including selecting based on received power.

10. The method of claim 1 including selecting based on network loading.

11. The method of claim 1 including selecting between tiers in a multitiered network.

12. The method of claim 1 including selecting a radio access technology in an integrated multi-radio access technology network.

13. A non-transitory computer readable medium storing instructions executed by a processor to:
assess a current condition on two available radio access technologies;
determine based on said condition which of the two technologies is more suited to achieving a quality of service metric; and
selecting one of the two available radio access technologies for a wireless communication based on said condition and said metric.

14. The medium of claim 13 further storing instructions to select a radio access technology using an offloading rule.

15. The medium of claim 13 further storing instructions to select between cellular and WiFi radio access technologies.

16. The medium of claim 13 further storing instructions to select using a load balancing consideration.

17. The medium of claim 13 further storing instructions to select based on a signal-to-noise ratio condition.

18. The medium of claim 13 further storing instructions to select based on a received power condition.

19. The medium of claim 13 further storing instructions to select based on a network loading condition.

20. The medium of claim 13 further storing instructions to select between tiers in a multitiered network.

21. A wireless device comprising:
a processor to evaluate a condition existing on two available radio access technologies and select one of the two available radio access technologies for a wireless communication based on said existing condition; and
a transceiver coupled to said processor.

22. The device of claim 21 said processor to select a radio access technology using an offloading rule.

23. The device of claim 21 said processor to select between cellular and WiFi radio access technologies.

24. The device of claim 21 said processor to select using a load balancing consideration.

25. The device of claim 21 said processor to select based on signal-to-noise ratio or received power.

26. The device of claim 21 said processor to select based on network loading.

27. The device of claim 21 said processor to select between tiers in a multitiered network.

28. The device of claim 21 said processor to select a radio access technology in an integrated multi-radio access technology network.

29. The device of claim 21 wherein said device is a subscriber station.

30. The device of claim 21 wherein said device is a base station or access point.
